(19) United States
(12) Patent Application Publication
(10) Pub. No.: US 2017/0091691 A1
(43) Pub. Date: Mar. 30, 2017

(54) SYSTEM FOR CONTROLLING THE SANITARY STATUS OF PREMISES AND METHOD FOR DETERMINING THE NEXT CLEANING

(71) Applicant: ANTALIOS, Marseille (FR)

(72) Inventors: Patrick ADAM, LA CIOTAT (FR); Christophe PISTORESI, LES PENNES MIRABEAU (FR)

(21) Appl. No.: 15/281,164

(22) Filed: Sep. 30, 2016

(30) Foreign Application Priority Data
Sep. 30, 2015 (FR) 15 59226

(51) Int. Cl. G06Q 10/06

(52) U.S. Cl. CPC G06Q 10/06316; G06Q 10/06313

(57) ABSTRACT

The disclosure relates to a control system (2) of the cleanliness of premises (1), especially toilet areas, the system comprising means for counting (4) the number of entrances to the premises, the counting means being capable of providing a counting datum, at least one panel (5) mounted in the premises and comprising means for signaling a cleaning need of the premises, the signaling means being capable of providing a satisfaction datum, and indication means for a cleaning agent to indicate the cleaning of the premises, the indication means being capable of providing a datum of the last cleaning comprising at least the date and the time of the last cleaning, wherein the counting, cleaning need and last cleaning data are used by an algorithm to program the next cleaning by a cleaning agent (AN).

### BACKGROUND OF THE DISCLOSURE

The present disclosure relates to a system which enables control of the sanitary status of premises, for example a sanitary unit, and a method for determining the time of the next cleaning.

The sanitary status of premises, for example a sanitary unit or “toilet areas” of a site (restaurant, commercial centre, airport, etc.), can vary as a function of the number of users, the number of cleaning agents available, the cleaning frequency, etc.

The level of cleanliness of the premises is often seen by the users as an indicator of the level of service and quality, and can leave a good or bad impression not only of the toilet areas, but of the site in general. However, it is difficult sometimes for owners of the site to keep toilet areas clean as a high number of users or disrespectful users can degrade them quickly, even though the toilet areas have just been cleaned.

A set cleaning program, for example once per time, risks not being sufficient if there is a large number of users in a short period (after the arrival of a plane or a bus for example), or cannot be necessary if there have been few users and/or if the latter did not mess up the premises. A variable cleaning program in which the owner asks the cleaning agents to periodically verify the toilet areas and clean them only if necessary, is also a waste of time and resources.

US patent U.S. Pat. No. 6,819,238 discloses a system for signaling a cleaning need. The system comprises a panel installed on the wall of the toilet, with a push button and a text which indicates that by pressing on the button the user can indicate that the toilet needs to be cleaned. The panel is connected to a signaling device installed outside, the device comprising a light which lights up once the button is pressed.

However, such a system has disadvantages, for example dishonest users can press the button even though the toilet areas do not need to be cleaned, obliging the cleaning agent to mobilize for no reason.

### SUMMARY OF THE DISCLOSURE

The main aim of the present disclosure therefore is to eliminate such disadvantages by proposing a system for controlling the cleanliness of premises, especially toilet areas, the system comprising:
means for counting the number of entrances to the premises, the counting means being capable of providing a counting datum,
at least one panel mounted in the premises and comprising:

means for signaling a cleaning need of the premises, the signaling means being capable of providing a satisfaction datum, and

indication means, for a cleaning agent to indicate the cleaning of the premises, the indication means being capable of providing a datum of the last cleaning comprising at least the date and the time of the last cleaning,

wherein the counting, cleaning need and last cleaning data are used by an algorithm to program the next cleaning by a cleaning agent.

Preferably, the counting and satisfaction data are linked to timestamps which are used by the algorithm.

Preferably also, the counting means counts the number of exits from the premises, the entry and exit data being timestamped and used to evaluate the average duration of each visit.

The panel can further comprise display of the datum of the last cleaning which is updated automatically during the cleaning indication by the cleaning agent via the indication means.

Similarly, the panel can further comprise display of the next cleaning calculated by the algorithm, the display of the next cleaning being adjusted in real time as a function of the counting, cleaning need and last cleaning data.

Preferably, the system is linked to a processing unit and configured to send the counting, cleaning need and last cleaning data to the processing unit, the processing unit to set up information lists about one or more panels, their placements, the last cleanings, the cleaning agents who performed them, the times and cleaning agents provided for the next cleanings, the daytime cleaning frequencies, the average levels of satisfaction, the total counts of users per day, the attendances per time period and/or the states of the panels.

The system can further comprise a display configured to indicate to users information on cleaning in progress or upcoming and/or other premises to be used.

The counting means can comprise two lasers mounted in the frame of a door, each laser having a beam which traverses the length of the door and a sensor facing the laser and which receives the beam, the order of interruption of the beams indicating the entrance or exit of a user.

The means for signaling the cleaning need can let users indicate a level of satisfaction of the cleanliness of the premises, which will be used to schedule the next cleaning. In this case the panel advantageously stores an indication of a level of satisfaction by a cleaning agent, this indication being used by the algorithm to evaluate indications by users.

Another aim of the disclosure is a method for determining the next cleaning of premises equipped with the system such as defined previously, the method comprising the steps of:

counting, by the counting means, the number of people who enter the premises,

providing a counting datum,

detecting the signaling, by a user, of a cleaning need of the premises via the signaling means

providing a satisfaction datum,

indicating, by a cleaning agent, the cleaning of the premises,

providing a datum of the last cleaning comprising at least the date and the time of the last cleaning, and

using, by an algorithm, the counting, cleaning need and last cleaning data to program the next cleaning by a cleaning agent.

Preferably, the time remaining before the next cleaning is calculated by an algorithm using a satisfaction coefficient determined according to levels of satisfaction indicated by the users, an attendance coefficient and the attendance indicated by the counting means.

The estimated use duration of the premises can be calculated by an algorithm which utilises entry and exit data supplied by the counting means.

A cleanliness capital can be calculated by an algorithm for linking the state of cleanliness of the premises to time, so as to calculate how soon the state of the toilet areas will need cleaning.

Yet another aim of the disclosure is a computer program stored on a non-temporary medium, the program comprising an algorithm configured to execute the method such as defined previously.

### BRIEF DESCRIPTION OF THE DRAWINGS

Other characteristics and advantages of the present disclosure will emerge from the following description in reference to the appended drawings which show an embodiment devoid of any limiting character, wherein:

FIG. 1 shows a frontal view of premises equipped with a cleaning control system according to an embodiment;

FIGS. 2A, 2B show a perspective view of a system for counting users and a frontal view of a satisfaction panel used in terms of the cleaning control system, and

FIG. 3 shows a graph between the time remaining before the next cleaning and time elapsed since the last cleaning.

### DETAILED DESCRIPTION

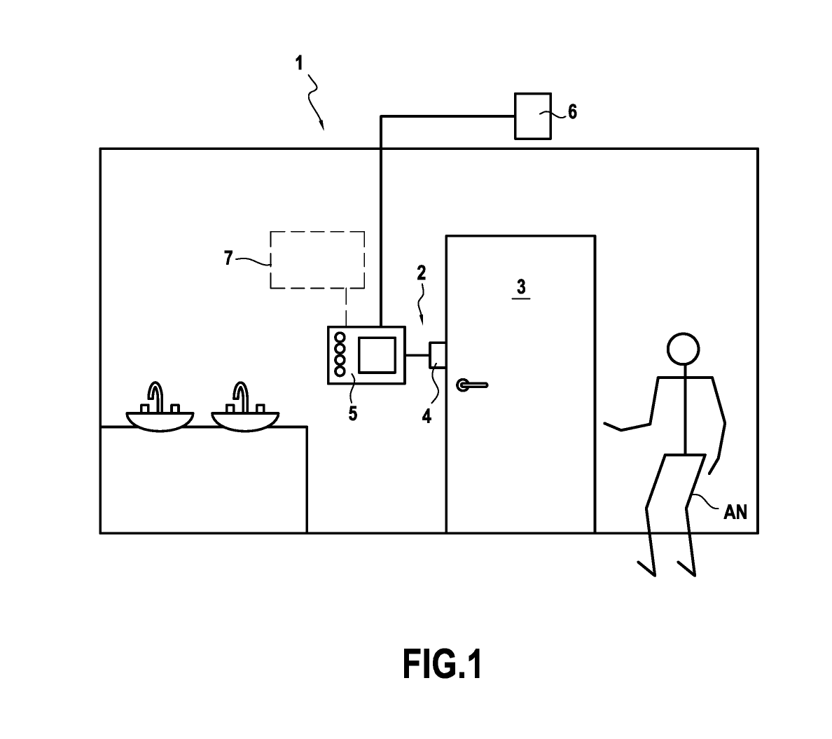

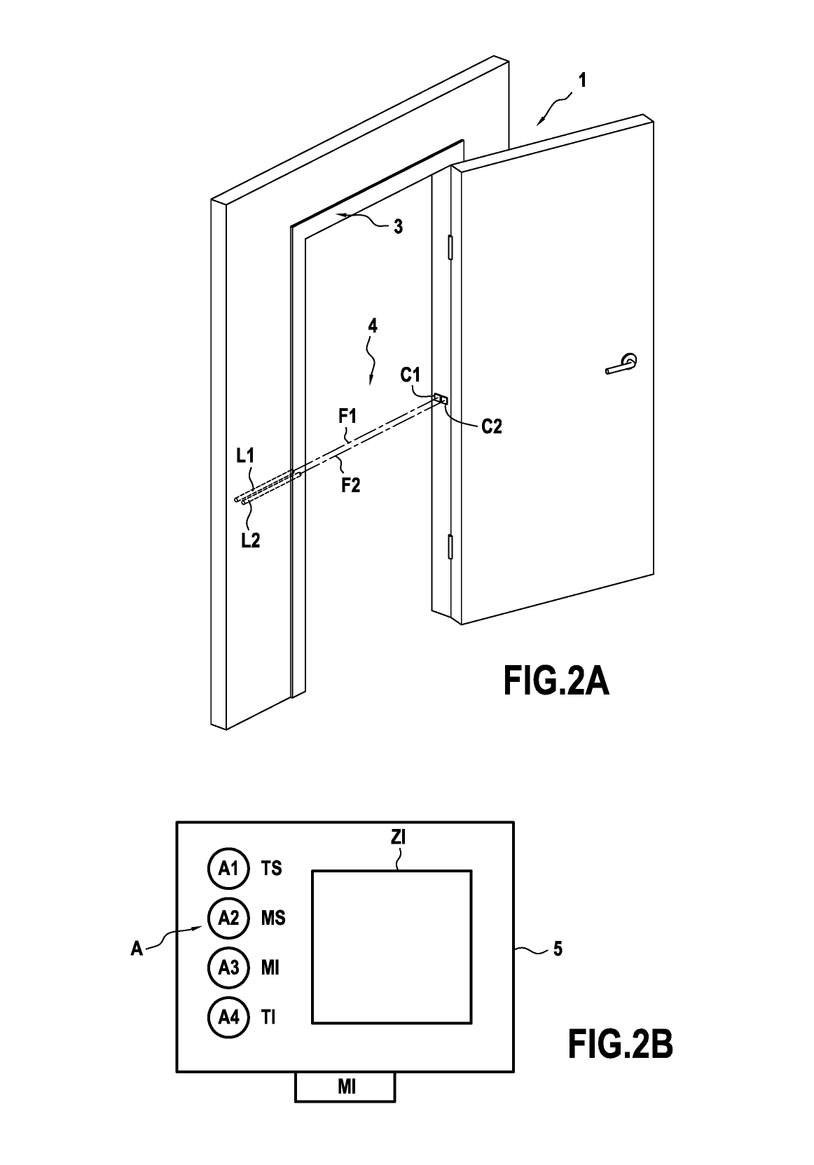

FIG. 1 shows a frontal view of premises 1 equipped with a sanitary control system 2. The premises 1, here the toilet areas, comprise toilets, sinks or washbasins, hand-drying stations, etc. The control system 2 comprises an entrance/exit 3 (here a door) equipped with counting means 4 of the number of entrances and exits by users (described in more detail in relation to FIG. 2A), a satisfaction panel 5 (mounted for example on the wall beside the door), a central data-processing unit 6 and a display 7 (mounted for example outside the toilet areas). A cleaning agent AN is responsible for cleaning the toilet areas 1 regularly, as a function of time since the last cleaning, the level of satisfaction of cleanliness indicated by users, and the number of users since the last cleaning.

FIG. 2A shows a perspective view of the means for counting users 4 or “counter”. The counter 4 is here an array of two lasers L1, L2 mounted parallel side by side, especially horizontally in the frame of the door 3, each laser L1, L2 having a respective laser beam F1, F2 which extends transversally in the opening of the frame of the door and which is captured by a respective sensor C1, C2, the sensors C1, C2 being mounted facing the lasers L1, L2 on the edges of the frame of the door 3. Any person entering or leaving interrupts the beams, either F1 first and then F2 for a person entering, or F2 first and then F1 for a person leaving. The sensors Cl, C2 send interruption data to the panel 5 which records the order of interruption (F1, F2 or F2, F1) linked to a timestamp of the interruption as counting datum.

FIG. 2B is a frontal view of the satisfaction panel 5 which comprises a instruction zone ZI, at least one means for signaling the level of satisfaction of the cleanliness of the premises, here an actuator A (for example, a push button and preferably several buttons A1, A2, A3, A4), and coupled to or comprising transit indication means MI of a cleaning agent AN.

The panel 5 is preferably connected to the counting means 4 and further comprises a clock and a power source (a storage battery or connection to an electric power network). Also, the panel 5 is solid and resists shocks and tearing away, or other forms of vandalism. The panel 5 can further comprise a memory for storing data, a data-processing unit, and data communication means, for example by USB key, by wired or wireless link, to the processing unit 6 and/or the display 7.

In this embodiment, the instruction zone ZI is a screen of liquid crystal display screen type (LCD) which asks users to indicate their level of satisfaction with the cleanliness of the premises by pressing the actuators A1 to A4 which are marked Highly Satisfied (TS), Moderately Satisfied (MS), Moderately Dissatisfied (MI), Very Dissatisfied (TI), etc. Pressing on one of these actuators is detected by the panel 5 which records it linked to a timestamp of the pressing as satisfaction datum.

The transit indication means MI let the cleaning agent signal his transit and comprises for example according to 1-wire or “Dallas key” technology, means of sending data with lower transmission speeds and cost. The signaling of transit is detected by the panel 5 which stores the signaling linked to a timestamp of the transit as datum of the last cleaning.

On his arrival and/or departure, the cleaning agent signals his transit which is stored with a timestamp of the transit. The identity of the agent can optionally also be associated with transit. These data are recorded and stored in the memory of the panel and/or sent to the processing unit 6. Also, the cleaning agent AN can evaluate the sanitary status of the toilet areas 1 and press the corresponding actuator. This evaluation is used to better relativize the satisfaction data of users who are not cleaning professionals and in general have more negative perceptions than reality. After transit of the cleaning agent AN, it is presumed that the level of cleanliness/satisfaction is reset at its highest (Highly Satisfied).

In an embodiment, the panel 5 further indicates the time of the last cleaning, preferably updated automatically during indication of the transit of the cleaning agent, and the time of the next programmed cleaning, which is modified as a function of the counting and satisfaction data.

In an embodiment, if the user gives a negative opinion (Moderately Dissatisfied or Very Dissatisfied), the time before the next cleaning diminishes as a consequence, for example by five or ten minutes respectively.

The use of counting, satisfaction, and of the last cleaning data to determine the time of the next cleaning will be explained in more detail below.

The panel 5 can enable other indications and possibilities, for example indicate the number of users since the last cleaning, let a user signal other information (medical emergency, need for toilet paper, etc.), inform users of the average evaluation of the premises, put a user in communication with an assistant, etc.

The processing unit 6 can be connected to several toilet areas 1, each being equipped with such a control system 2. The processing unit 6 enables management of user flow. For example, a first toilet detects that there has been considerable transit of users and that its sanitary status has dropped, where as a second toilet has been underused and remains relatively clean. The display 7 outside the first toilet redirects users to the second toilet. Likewise, cleaning in progress or yet to come, a great number of users presents at the same time, or any other reason, can be displayed and/or cause redirection of users.

From the processing unit 6 a person responsible can access information, for example a list of panels 5 installed on site and/or a list of cleaning agents AN. In the case of a list of panels 5 the information about a designation of the panel, its placement, the last cleaning, the agent who performed it, the time and the agent provided for the next cleaning, the cleaning frequency in the daytime, the average level of satisfaction, the counting of total users per day, the attendance per time period, the state of the panel in real time (the state of the battery, state of the connection to the counting means 4 and/or the processing unit 6), etc.

The list on the cleaning agents AN can include the number of cleanings performed per day, per time, the time passed for each cleaning (by scoring before and after the cleaning), the evaluation of his work, etc.

Also, it is possible to consult the work statistics, display a curve representative of cleaning frequency, display a curve representative of the level of overall satisfaction or per site, etc.

Table 1 hereinbelow gives an example of use of the control system 2 for cleanliness of the premises 1. At 12:10, the cleaning agent finishes the cleaning, signals his transit, and the level of satisfaction is reset to the highest Highly Satisfied (4). At 12:15, one person enters and leaves a Moderately Satisfied evaluation (3). At 12:16, two people enter but leave no evaluation. At 12:18, two people enter and leave a Highly Satisfied evaluation (4). At 12:20, one person enters and leaves a Moderately Satisfied evaluation (3). At 12:21, one person enters and leaves a Very Dissatisfied evaluation (1). At 12:25, one person enters and leaves a Moderately Satisfied evaluation (3). At 12:30, one person enters and leaves a Moderately Dissatisfied evaluation (2). At 12:34, two people enter and leave a Moderately Dissatisfied evaluation (2). At 12:40, one person enters and leaves a Very Dissatisfied evaluation (1).

TABLE 1

| | Transit | Time | Satisfaction |
|---|---|---|---|
| 1) | Cleaning agent | 12:10 | 4 |
| 2) | 1 person | 12:15 | 3 |
| 3) | 2 people | 12:16 | X |
| 4) | 2 people | 12:18 | 4 |
| 5) | 1 person | 12:20 | 3 |
| 6) | 1 person | 12:21 | 1 |
| 7) | 1 person | 12:25 | 3 |
| 8) | 1 person | 12:30 | 2 |
| 9) | 2 people | 12:34 | 2 |
| 10) | 1 person | 12:40 | 1 |

The following can be noted relative to the table:

In case 2), there was no visit of the premises between the cleaning agent and the person responsible for the evaluation. It can be considered that his evaluation of Moderately Satisfied (3) is not quite in keeping with reality, therefore less importance (weight) can be given to this evaluation.

In case 6), as the preceding evaluation is relatively high (Moderately Satisfied), and the following evaluation is also relatively high (Moderately Satisfied), it can be considered that his evaluation of Very Dissatisfied is not quite appropriate (or he is more demanding than the others, or he tries to falsify the data) less importance (weight) can be given to this evaluation.

Finally, from case 8) it can be considered that the sanitary status deteriorates, with several successive evaluations being increasingly negative.

The evaluations can be also used to evaluate the work of the cleaning agent AN and/or the level of cleanliness required. In the first case, if immediately after intervention of the agent the level of satisfaction is average, the work of the agent must be checked. In the latter case, the cleaning standards of the premises in general must be raised.

It is possible to have a “temporary” version of the system, which evaluates the behaviour of users over a given duration, for example a few months, to set up a suitable cleaning programme. Next, the system will be removed or replaced by a set system. Also, simple counting of users, without putting the panel 5 and the rest of the system in place, can be employed in a first instance to set up a first cleaning program which will be refined over time.

Algorithms

Cleanliness Capital

A “cleanliness capital” CP value can be used to link the state of cleanliness of the toilet 1 to the time, especially the time remaining TR before the next cleaning, to calculate how soon the state of the toilet areas will need cleaning. So the most adequate time for the next cleaning can be determined.

This cleanliness capital CP depends on the time elapsed TP since the last cleaning, the number of users meanwhile, and the level of satisfaction.

It has been noted that in general the state of cleanliness depends not only on the number of users over a period, but also on the time distribution of the number of users. More exactly, a large number of users in a short period messes up the toilet areas more quickly relative to the same number of users over a longer period. Large attendance in general creates stress for hurrying, and users tend to leave deteriorates of water on the hand basins, traces of soap, serviettes overflowing from the wastebasket, etc.

The aim here is to enable the control system 2 to be able to determine and auto-adjust the initial value of the cleanliness capital CP as a function of events which can vary from one toilet to another.

The algorithm should:

have the initial value vary in the medium term (several cleaning cycles necessary for an adjustment);

increase or decrease the value of the cleanliness capital CP; and

consider the opinion of the cleaning agent AN during transit.

As a consequence, an initial value CP0 is determined as a function of the work habits of the cleaning teams already in service, i.e., the average interval between two transits in the same toilet, adjusted with an experimental coefficient which will be refined with use, as given by the following equation:

CP₀=IM×CO_{EX} [equation 1]

wherein CP₀ is the initial cleanliness capital, IM is an average interval (for example, 60 minutes), and CO_{EX} is an experimental coefficient which considers the variations between two cleaning cycles.

The opinion of the cleaning agent AN during his arrival on site is taken into account in the calculation to adjust the initial value of the cleanliness capital CP.

If the evaluation of the agent is negative (value 1, 2), his intervention is justified, and the cleanliness capital does not change:

CP_{N+1}=CP_{N} [equation 2]

If the evaluation of the cleaning agent AN is positive (value 3, 4), his intervention could have waited since the toilet areas are still clean when he arrives.

As a consequence, the cleanliness capital CP can be increased as follows:

CP_{N+1}CP_{N}+(CO_{AN}×CP_{N}) [equation 3]

wherein CO_{AN} is an evaluation coefficient by the agent which can vary, for example a “very good” evaluation creates an increase in the capital greater than a “good” evaluation.

The initial value CP₀ and the coefficients CO_{EX}, CO_{AN} will be refined with use of the toilet areas so that in time the cleanliness capital CP of the toilet areas is highly predictable.

Percentage of Satisfaction

The satisfaction percentage PS is defined as the sum of the positive opinions (Very Satisfied and Moderately Satisfied) divided by the total number of opinions, given by the following equation:

PS=(NE_{TS}+NE_{MS})/(NE_{T})×100 [equation 4]

wherein NE_{TS} is the number of Very Satisfied evaluations, NE_{MS} is the number of Moderately Satisfied evaluations, and NE_{T} is the total number of evaluations, i.e.:

NE_{T}=NE_{TS}+NE_{MS}+NE_{MI}+NE_{TI} [equation 5]

wherein NE_{MI} is the number of Moderately Dissatisfied evaluations and NE_{TI} is the number of Very Dissatisfied evaluations.

If the total number of evaluations NE_{T} is equal to 0, an eventual equipment breakdown can be suspected. For example, if the counter 4 indicates that ten users have used the toilet areas but none has left an evaluation, it is possible that the system is malfunctioning. The satisfaction percentage PS can be put at 0% or at another estimated value, and an agent can be sent on site to verify proper operation of the system.

On the contrary, if the counter 4 shows that no person has entered since the last cleaning, it is considered that the level of cleanliness is always maximum and the satisfaction percentage PS is set at 100%.

Also, if the system 2 notes that over a time interval there has been no detection of transit, it can trigger a verification procedure, especially if necessary over a time of high attendance (during the day).

Calculation of Duration Before Transit

The following equation calculates, at time N, the time remaining TR at time N+1 before the next cleaning:

TR_{N+1}=TR_{N}−(CO_{PS})*(ΔT)−(CO_{FR})*(F_{N+1}−F_{N}) [equation 6]

wherein TR_{N+1} corresponds to the time remaining TR at time N+1, TR_{N} corresponds to the time remaining TR currently at time N, CO_{PS} corresponds to a satisfaction coefficient, ΔT corresponds to the interval between two calculations, CO_{FR} corresponds to an attendance coefficient, F_{N+1} corresponds to attendance at time N+1, and F_{N} corresponds to attendance at time N.

The satisfaction coefficient can be equal to 1.5 if the satisfaction percentage PS is less than or equal to 40% (PS≦0.4), equal to 1 if the satisfaction percentage PS is between 40 and 70% (0.4<PS<0.7) and equal to 0.5 if the satisfaction percentage PS is greater than or equal to 70% (0.7≦PS). I.e., the delay before the next cleaning is shortened relative to the standard delay if the satisfaction is below the standard level, remains unchanged if the satisfaction matches the standard level, and prolonged if the satisfaction is above the standard level.

The attendance coefficient CO_{FR} is determined experimentally by an audit on the installation location.

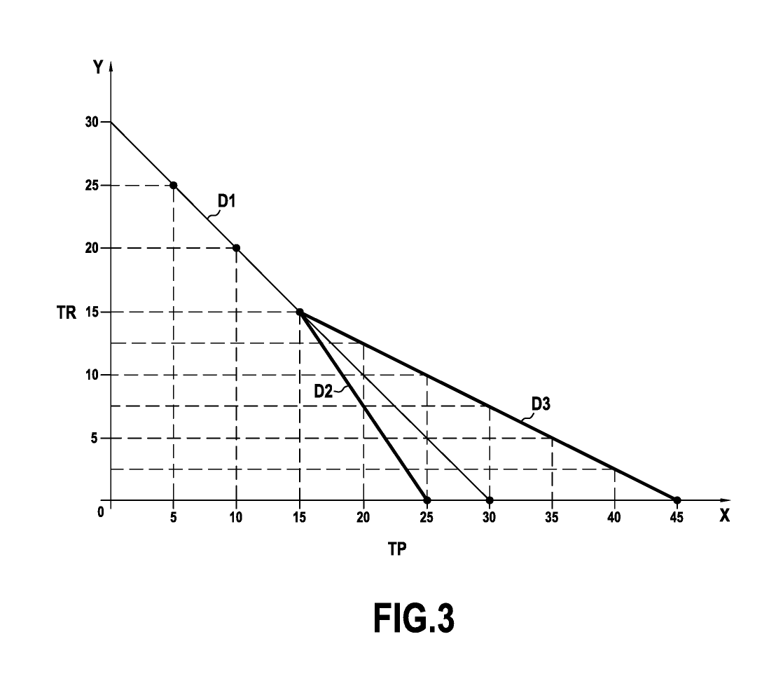

FIG. 3 shows a graph for calculation of the next cleaning PN, with the time remaining TR on the y-axis and the elapsed time TP on the X-axis, a curve D1 of the programmed duration, and two curves D2, D3 of the duration modified according to the counting and/or satisfaction data. “Negative” data (substantial attendance and/or negative evaluations) reduce the duration before the next cleaning, as shown on curve D2 and “positive” data (light attendance and/or positive evaluations) increase the duration before the next cleaning, as shown on curve D3.

Here, the value of the time remaining is updated every five minutes (ΔT=5 minutes), but it can be updated more or less frequently.

For the following practical examples, the attendance coefficient CO_{FR}, and the attendance (F_{N+1}-F_{N}) are not considered, for reasons of simplicity. In general, the attendance coefficient CO_{FR} will not vary greatly from one cycle to the other, whereas attendance varies. The attendance coefficient CO_{FR} gives more or less importance to the attendance parameter (F_{N+1}-F_{N}).

As a function of premises, time or users, the coefficient can be modified so that the attendance is more or less considerable on decrease of the cleanliness capital. For the same premises, according to the day, the time, and other factors, the transit of a certain number of users in the toilet areas will not have the same impact. To be able to predict attendance between time N and time N+1, there needs to be enough historic data recorded to conduct statistical analysis of events and best provide future attendance.

At elapsed time 0 TP=0, the toilet areas have just been cleaned, and there are 30 minutes TR₀=30 before the next programmed transit. The next time remaining TR at 5 minutes (TP=5) is equal to:

TR₅=30−(1)*(5)=25 minutes

At elapsed time TP=5 minutes, the satisfaction percentage is 65%, giving:

TR₁₀=25−(1)*(5)=20 minutes

At time T=10 minutes, the satisfaction percentage is 50%, giving:

TR₁₅=20−(1)*(5)=15 minutes

From 15 minutes, two hypotheses are shown, D2, D3. In the case of D2, it is considered that the sanitary status deteriorates, with a satisfaction percentage of less than 40%.

TR₂₀=15−(1.5)*(5)=7.5 minutes, and then

TR₂₅=7.5−(1.5)*(5)=0 minutes.

The next cleaning is then programmed to take place at 25 minutes, instead of 30 minutes.

In the case of D3, it is considered that the sanitary status improves, for example a user who has balled up paper serviettes and thrown them into the waste bin, with a satisfaction percentage greater than 70%.

TR₂₀=15−(0.5)*(5)=12.5 minutes and so on, with a total final time of 45 minutes between cleanings.

Calculation of time before the next transit can therefore be compared to predictive managing of supply, and irrespective of the field of application the principle is identical.

Calculation of the Response Time

The response time of a cleaning agent AN can be calculated to program the response at the best moment possible by taking into consideration the time necessary for him to arrive on site. In this way he can be alerted as late as possible, but soon enough for him to be operational when the cleanliness capital CP is exhausted, neither before, nor after.

To do this, initial response is set to correspond to a certain percentage of the initial capital.

D₀=CO_{CP}*CP₀

wherein D₀ corresponds to the initial response, CO_{CP} corresponds to a coefficient of the cleanliness capital CP, and CP₀ corresponds to the initial cleanliness capital. In practice, the coefficient CO_{CP} is comprised between 0% and 15%. For example, if the capital CP₀ is equal to five hours (300 minutes) and the coefficient CO_{CP is} equal to 5%, the response is equal to =0.05*300=15 minutes.

The cleaning agent AN is forewarned that in fifteen minutes the state of the toilet areas will no longer be acceptable, and the real response time is calculated. The response D₀ is recorded, and over time an average is calculated with the initial value, producing an increasingly exact response.

The standard deviation of all the values pointed out is determined so as to take into account the uncertainties which are there or can occur during cleaning sessions.

Two different ways of estimating the response can be used, each having advantages and disadvantages as a function of the type of premises to be equipped, teams standing by in place and the overall use of the toilet areas in question:

D_{N+1}=AVG(D)±σ [equation 7]

wherein σ (sigma) corresponds to the standard deviation. To arrive earlier, sigma is added to the average and to arrive later, sigma is subtracted from the average.

The following equation shows the average of responses of the cleaning agent AN from the commissioning of the system (or reset):

AVG(D_{N})=1/N*ΣD_{K=0 to N} [equation 8]

The following equation shows the standard deviation of all the values pointed out:

σ_{N}=√(Σ_{K=0 to N}(Dₖ−AVG(D_{N}))² [equation 9]

In this way the value is adjusted during use of the panel 5 so as to be the most optimal possible. So a cleaning agent AN will be notified at the most suitable moment, and productivity will be improved by eliminating to a maximum the loss of unuseful time. Also, the toilet areas will not remain in a state of excessive dirtiness for a long time, ensuring a high level of service.

It is evident in this approach that the response time is considered as following a law of normal distribution. Yet another law can be used to improve estimation of the response.

Also, the response time can consider other data, for example, if the cleaning agent AN is currently active in another toilet, the time necessary for him to arrive at the new site, and if he is on break, the duration of that, etc.

Also, the calculation program can also consider the level of satisfaction to program the response. For example, if the level of satisfaction is very low it can be considered that more time is need for cleaning.

Calculation of Attendance Per Interval

The attendance of toilet areas can be calculated per time interval, i.e. for example over a day (24 hours) and by one hour increment.

In the following example a table is created comprising all the values of the day (or of the measuring duration) distributed according to an index which indicates the interval in question, a counter which corresponds to the attendance measured and a timer which corresponds to the duration of the remaining interval.

In a first initialisation step, shown here, the indices are set to zero, a table (Table 2 hereinbelow—Note: The tables hereinbelow show 6 intervals of 4 hours each only, for reasons of simplicity) is created comprising n elements according to the number of intervals. The attendances measured for each interval are also set to zero and the interval durations are taken at 4 h (240 minutes). (It is noted that the durations of intervals are not exactly equal, but can be more or less long according to the different periods of the day, for example an interval of 22 h to 8 h, and then intervals of two hours.)

TABLE 2
Counter = 0

| Index | Measured attendance | Duration of the remaining interval |
|---|---|---|
| 0 | 0 | 240 minutes |
| 0 | 0 | 240 minutes |
| 0 | 0 | 240 minutes |
| 0 | 0 | 240 minutes |
| 0 | 0 | 240 minutes |
| 0 | 0 | 240 minutes |

In a second measuring step, the table (Table 3—hereinbelow) is updated according to the data of the counting means 4. As soon as response relative to movement is detected (either entrances or exits according to the configuration and the installation of the system), the value of the counter is increased =counter+1. Once the timer of the remaining interval has expired, the interval is terminated, and the value of the counter is recorded in the column “Measured Attendance”.

Table 3 shows a terminated index 1, with 5 attendances, and 0 minute remaining. The index is increased at 2, the counter is counting interruptions again, 200 minutes remaining in the interval. In summary, the value of the counter for the interval which has just finished is recorded relative to the corresponding interval of the table, the value of the counter is reset, the index is increased to move to the next interval, the timer is restarted and the counter restarts.

TABLE 3
Counter = 6

| Index | Measured Attendance | Duration of the remaining interval |
|---|---|---|
| 1 (0:00 to 3:59) | 5 | 0 minutes |
| 2 (4:00 to 7:59) | 0 | 200 minutes |
| 0 | 0 | 240 minutes |
| 0 | 0 | 240 minutes |
| 0 | 0 | 240 minutes |
| 0 | 0 | 240 minutes |

As shown in table 4 hereinbelow, the measuring period, here 24 hours, is terminated. The table is completed. The index is increased by 6 to 7, which is greater than the maximal size (index=6) of the table, therefore the table is recorded and the index is reset.

Counter = 0

| | | Duration of the remaining |
|---|---|---|
| Index | Measured Attendance | interval |
| 1 (0:00 to 3:59) | 5 | 0 minutes |
| 2 (4:00 to 7:59) | 7 | 0 minutes |
| 3 (8:00 to 11:59) | 25 | 0 minutes |
| 4 (12:00 to 15:59) | 30 | 0 minutes |
| 5 (16:00 to 19:59) | 27 | 0 minutes |
| 6 (20:00 to 23:59) | 10 | 0 minutes |

A circular buffer can be used to save data cyclically as that of attendance per time period.

Estimated Duration of Use of Toilet Areas

The average time of use of the toilet areas, even approximately, can be estimated by way of an algorithm.

For this to happen it is necessary to record all movements made in the toilet areas and to know the timestamp relative to the start of the cleaning cycle. The entrances/exits and their timestamps relative to the start of the cleaning cycle are correlated to have a value which shows an average duration which will be refined throughout commissioning of the system as the higher the number of elements, the closer the expressed value will be to the average time of use.

The algorithm is therefore broken down into two parts, the first corresponding to the recording in the form of a table of all the entrance and exit events with their timestamps. Two counters are used: one for the entrances and one for the exits and a timer which is started at the beginning of the cleaning cycle, when the cleanliness capital is at its highest. When an entrance or an exit is detected, the value of the timer at the moment of interruption is read and stored in the case of the table having the index of the current counter of entrances or exits. The entrance or exit counter is incremented and once the table is filled, whether the cleaning cycle is finished or simply there are enough elements for a coherent average to be calculated, the average duration is calculated.

The number of elements of the table to be considered is determined and a temporary table comprising the time difference between each entrance and each exit is obtained:

Δi=|Si−Ei| [equation 10]

wherein Si is the exit corresponding to an index i, Ei is the entrance corresponding to an index i, and Δi (delta i) is the difference between both.

The k-th percentile (in principle k is between 50 and 98) of the temporary table is calculated, which eliminates those values too far from the general average, and the resulting value is multiplied by a coefficient calculated experimentally to obtain the estimated value of the average time of use.

DEU=CO_{CR}*Δk-th percentile [equation 11]

wherein DEU is the estimated use duration and CO_{CR} corresponds to a correction coefficient.

It will be understood by those skilled in the art that embodiments of the disclosure described can be executed in different ways, with different algorithms used, means of storing and/or processing data, etc.

In other embodiments the instruction zone ZI of the panel 5 can be a touch screen integrating actuators, instructions written on a sticker or directly on the panel, etc. Also, the panel 5 does not necessarily offer a choice of several levels of satisfaction, but can quite simply ask users to indicate a cleaning need by pressing an actuator marked “Yes”.

The indication means MI for transit of a cleaning agent AN can be a digital keypad for entering an identifying code, a contactless card reader carried by the agent, a biometric reader (fingerprints . . . ) etc.

Instead of a laser device as described in relation to FIG. 2B, any other means for counting the entrances/exits can be put in place, for example a pressure mat, a camera which counts automatically (without needing the presence of an operator), etc.

Also, the satisfaction and counting data are not necessarily timestamped. The system can quite simply take into consideration the number of entrances, the level of satisfaction, and the time since the last cleaning to program the next cleaning, without need the timestamp of each event.

Also, it is not necessary for the counting means to count the number of exits.

Finally, instead of a panel 5 which itself comprises a memory and receives data from the counter, the counter 4 can send the counting data to the processing unit 6, either in real time, which lets the processing unit perform the timestamp and analysis, or in a deferred manner.

1. A system for controlling the cleanliness of premises, especially toilet areas, comprising:
a counter configured to count the number of entrants to the premises, the counter being capable of providing a counting datum,
at least one control panel mounted in the premises and comprising:
an indicator configured to signal a cleaning need of the premises, the indicator being capable of providing a satisfaction datum,
an input device enabling input from a cleaning agent indicating a cleaning of the premises, the interface being capable of providing a datum of the last cleaning comprising at least a date and time of a last cleaning,
a memory for storing the counting, cleaning need and last cleaning data and
a processing unit configured to determine, based on the counting, cleaning need, and last cleaning data, a next cleaning to be performed by a cleaning agent.

2. The system according to claim 1, wherein the counting and satisfaction data are linked to timestamps.

3. The system according to claim 1, wherein the counter is also configured to count the number of users exited from the premises, the entry and exit data being timestamped and used to evaluate the average duration of each visit.

4. The system according to claim 1, wherein the at least one control panel further comprises a display configured to display the datum of the last cleaning which is updated automatically during upon receiving a cleaning indication from the cleaning agent via the input device.

5. The system according to claim 1, wherein the at least one control panel further comprises a display configured to display the determined next cleaning, the next cleaning being adjusted in real time as a function of the counting, cleaning need and last cleaning data.

6. The system according to claim 1, wherein the system is linked to a second processing unit and configured to send the counting, cleaning need and last cleaning data to the second processing unit, the second processing unit being configured to provide information lists about one or more control panels, their placement, the last cleanings, the cleaning agents who performed the last cleaning, the times and cleaning agents provided for the next cleanings, the daytime cleaning frequencies, the average levels of satisfaction, the total counts of users per day, the attendances per time period and/or the states of the control panels.

7. The system according to claim 1, further comprising a display configured to indicate to users information on cleaning in progress or upcoming and/or other premises to be used.

8. The system according to claim 1, wherein the counter comprises two lasers mounted in the frame of a door, each laser having a beam which traverses the length of the door and a sensor facing the laser and which is configured to receive the beam, the order in which the beams are interrupted indicating the entrance or exit of a user.

9. The system according to claim 1, wherein the indicator for the cleaning need enables users to indicate a level of satisfaction of the cleanliness of the premises, and wherein the indication is used for determining a schedule of the next cleaning.

10. The system according to claim 9, wherein the control panel stores an indication of a level of satisfaction by a cleaning agent, this indication being used to evaluate indications by users.

11. A method for determining the next cleaning of a premises, comprising:
counting, by a processor, the number of people who enter the premises,
providing a counting datum,
receiving a user indication of a cleaning need of the premises,
providing a satisfaction datum,
indicating, by a cleaning agent, the cleaning of the premises,
providing a datum of the last cleaning comprising at least the date and the time of the last cleaning, and
determining, by the processor, based on the counting, cleaning need, and last cleaning data a next cleaning to be performed by a cleaning agent.

12. The method according to claim 11, wherein the time remaining before the next cleaning is calculated based on a satisfaction coefficient determined according to levels of satisfaction indicated by the users, an attendance coefficient and the attendance indicated by the counting.

13. The method according to claim 11, wherein the estimated use duration of the premises is calculated based on entry and exit data supplied by a counter.

14. The method according to claim 11, wherein cleanliness is calculated for linking a state of cleanliness of the premises to a time, so as to calculate when the premises will need cleaning.

15. A computer program stored on a non-transitory medium, the program comprising an algorithm configured to execute the method according to claim 11.
